(19) United States
(12) Patent Application Publication
(10) Pub. No.: US 2009/0247685 A1
(43) Pub. Date: Oct. 1, 2009

(54) NANO-METAL PARTICLE-CONTAINING POLYMER COMPOSITES, METHODS FOR PRODUCING SAME, AND USES FOR SAME

(76) Inventors: Fernando De La Vega, Zichron Yacov (IL); Arkady Garbar, Yoqneam Illit (IL); Claudio Rottman, Modieen (IL)

Correspondence Address: FISH & RICHARDSON P.C., PO BOX 1022, MINNEAPOLIS, MN, 55440-1022, US

(21) Appl. No.: 11/909,707

(22) PCT Filed: Mar. 23, 2006
(86) PCT No.: PCT/IB06/00663

§ 371 Date: May 16, 2008

Related U.S. Application Data
(60) Provisional application No. 60/665,632, filed on Mar. 25, 2005.

(51) Int. Cl. C08K 3/08; C09K 3/00; C08K 7/18

(52) U.S. Cl. 524/440; 252/182.12; 524/441; 524/543; 524/585; 524/565; 524/500; 524/521; 977/773

(57) ABSTRACT

Composites featuring nano-metal particles in a polymer matrix, as well as methods and compositions, for making such composites and uses for such composites (e.g., as masterbatches) are described.

### TECHNICAL FIELD

This invention relates to preparing nano-metal particle-containing polymer composites.

### BACKGROUND

Metal particles have been incorporated in polymers to form composites useful in a variety of applications. However, it is often difficult to disperse the particles in the polymer matrix, particularly at high particle loadings.

### SUMMARY

In one aspect, there is described a composition comprising nano-metal particles dispersed in a liquid carrier that includes caprolactam. In some embodiments, the amount of caprolactam may constitute up to about 35 or 40% of the composition by weight, based upon the total weight of the composition.

The composition may be in the form of an emulsion. In some cases, the liquid carrier of the composition includes water, a water-miscible solvent, or a combination thereof. In other cases, the liquid carrier may include an organic solvent (e.g., a water-immiscible organic solvent). Examples of other agents that may be included in the composition are polymers, binders, surfactants, dispersants, coupling agents, and combinations thereof.

The nano-metal particles preferably include a metal element selected from the group consisting of silver, gold, platinum, palladium, nickel, cobalt, copper, and combinations thereof, and preferably have a D₉₀ value of less than 0.1 μm. They may be prepared according to a process that includes (a) forming an alloy comprising an auxiliary metal (e.g., aluminum) and a metal; and (b) treating the alloy with a leaching agent to remove the auxiliary metal. Examples of suitable processes are described in U.S. Pat. Nos. 5,476,535 and 6,012,658, and published PCT application no. WO 2004/000491 entitled “A Method for the Production of Highly Pure Metallic Nano-Powders and Nano-Powders Produced Thereof,” each of which is hereby incorporated by reference in its entirety.

In a second aspect, there is described a composite that includes nano-metal particles in a solid polymer matrix. Examples of suitable nano-metal particles include the materials described above. Examples of suitable polymer matrix materials include thermoplastic polymers such as polyolefins (e.g., polyethylene), styrene-acrylonitrile (SAN) copolymers, and acrylonitrile-butadiene-styrene (ABS) terpolymers.

In a third aspect, there is described a method for making a composite that includes: (a) providing a masterbatch that includes nano-metal particles in a first polymer matrix; and (b) combining the masterbatch with a second polymer that is the same as, or compatible with, the first polymer matrix, to form a composite comprising nano-metal particles in a matrix comprising the first and second polymers. The second polymer to which the masterbatch is added may be in the form of a polymer melt or a polymer solution.

Examples of suitable nano-metal particles include the particles described above. In one exemplary embodiment, the first polymer includes styrene-acrylonitrile (SAN) copolymer and the second polymer includes acrylonitrile-butadiene-styrene (ABS) terpolymer.

In a fourth aspect, there is described a method for making a composite that includes: (a) providing a first composition comprising nano-metal particles dispersed in a liquid carrier; (b) combining the composition with a solution comprising a first polymer dissolved in a solvent to form a second composition; and (c) precipitating a composite comprising nano-metal particles and the first polymer from the second composition. The resulting composite may subsequently be used as a masterbatch by combining it with a second polymer that it the same as, or compatible with, the first polymer to form a second composite featuring the nano-metal particles in a matrix comprising the first and second polymers. Examples of suitable materials for the nano-metal particles and the polymers are described above. The first composition may include the ingredients described above in the first aspect.

In a fifth aspect, there is described a composite that includes nano-metal particles in a polymer matrix, where the composite is substantially transparent and colored, even in the absence of an externally added colorant (e.g., a pigment or a dye). In some embodiments, the composite is substantially transparent and yellow.

In a sixth aspect, there is described a composite that includes nano-metal particles, preferably nano-silver particles, in a polymer matrix that has anti-microbial properties and that can be used to form a variety of articles, including certain medical and surgical devices, that are resistant to microbial growth. Non-limiting examples of such articles include tubing for infusing therapeutic fluids such as electrolyte solutions, nutrients, drugs, blood products, and the like into patients, containers in which such therapeutic liquids are stored prior to and during infusion, surgical drapes, wound dressings, textiles, building and air-conditioning materials, and other applications where anti-microbial activity is desirable.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a photograph illustrating two injected molded polyethylene samples, one of which includes silver nano-particles and the other which does not.

FIG. 2 is a graph illustrating the particle size distribution of a silver nano-particle dispersion (“DA-5”) described in Example 6.

FIG. 3 is a graph illustrating the particle size distribution of a second silver nano-particle dispersion (“DA-51”) described in Example 6.

FIGS. 4 and 5 are SEM photographs of a composite (“NY-011”) featuring nano-metal particles in a polyamide matrix that is described in Example 7.

FIG. 6 is a graph illustrating the particle size distribution of a silver nano-particle dispersion (“DA-6”) described in Example 8.

FIG. 7 is a graph illustrating the particle size distribution of silver nano-particle dispersion DA-6 after it has been heated to the boiling temperature of the liquid carrier.

FIG. 8 is a graph illustrating the particle size distribution of silver nano-particle dispersion DA-5 (Example 6) after it has been heated to the boiling temperature of the liquid carrier.

FIGS. 9 and 10 are SEM photographs of a composite (“NY-012”) featuring nano-metal particles in a polyamide matrix that is described in Example 9.

FIGS. 11 and 12 are graphs illustrating the particle size distribution of a silver nano-particle dispersion (“NY-009”) that includes caprolactam and is described in Example 10.

FIGS. 13 and 14 are graphs illustrating the particle size distribution of a silver nano-particle dispersion (“NY-013”) that includes caprolactam and is described in Example 11.

Like reference symbols in the various drawings indicate like elements.

### DETAILED DESCRIPTION

The composites include nano-metal particles in a polymer matrix. In some embodiments, the composite may be used as a masterbatch to make a second composite. In some embodiments, the composites are transparent and colored in the absence of an externally added colorant (e.g., a pigment or dye).

### Example 1

A solution of 71.0 mg silver formate and 0.28 g trioctylphosphine (TOP) in 40 g of toluene was prepared. The solution was heated to 70° C. to reduce the silver formate to silver metal, resulting in the creation of a clear, dark brown solution of colloidal silver. Next, 18.6 g of wax (melting point 126° C.) was added to the colloidal silver solution at 70° C. and mixed until the wax completely dissolved, after which toluene was evaporated from the solution at 130° C. After cooling, 20 g of dark brown colloidal silver was obtained (silver concentration=0.25% (w/w)). The colloidal silver (5% by weight) was combined with polyethylene in an extruder. The composition was extruded to yield a clear, light yellow composite in which colloidal silver (about 0.0125% by weight) was dispersed in a polyethylene matrix. When the composite was then injection molded in the form of a plate, the injection molded plate was also clear and light yellow in color. In contrast, an injection molded polyethylene plate lacking the colloidal silver particles lacked the yellow color. The two injection molded plates are shown in FIG. 1.

### Example 2

A solution of 20.9 mg silver formate and 0.25 g trioctylphosphine (TOP) in 20 g of toluene was prepared. The solution was heated to 70° C. to reduce the silver formate to silver metal, resulting in the creation of a clear, dark brown solution of colloidal silver. Next, 12.9 g of wax (melting point 126° C.) was added to the colloidal silver solution at 70° C. and mixed until the wax completely dissolved, after which toluene was evaporated from the solution at 130° C. After cooling, 14 g of dark brown colloidal silver was obtained (silver concentration=0.1% (w/w)). The colloidal silver (5% by weight) was combined with polyethylene in an extruder. The composition was extruded to yield a clear, light yellow composite in which colloidal silver (about 0.005% by weight) was dispersed in a polyethylene matrix. When the composite was then injection molded in the form of a plate, the injection molded plate was also clear and light yellow in color.

### Example 3

A nano-silver dispersion (AG457) was prepared as follows. 48 g of methyl ethyl ketone (MEK) and 0.4 g of SPAN-20 (available from Fluka) were combined, after which 2 g of silver nano-powder (“P200,” prepared as described in PCT WO 2004/000491, table 2, with Span 20 and hexadecanol), was added. After 4 min. of sonication at 90% power, the particle size distribution (PSD) of the dispersion, as measured using Coulter laser diffraction equipment, had 2 peaks. An additional 2 min. of sonication resulted in a PSD having only one peak and a D₁₀₀ value less than 100 nm. The formulation of the dispersion is summarized in Table 1. All percentages are weight percentage.

TABLE 1

| | Name | % |
|---|---|---|
| Solvent | MEK | 95.24 |
| Silver powder | P200 | 3.97 |
| Surfactant | SPAN-20 | 0.79 |
| Total | | 100 |

The dispersion was used to prepare the composites described in Examples 4 and 5.

### Example 4

200 g of styrene-acrylonitrile copolymer (LURAN® Q53) was dissolved in 670 g of MEK at room temperature, after which 10 g of the nano-silver powder dispersion in MEK prepared according to Example 3 was added. After 5 min. of stirring, the mixture was transferred to a flat baking mold and dried overnight at 100° C. After drying, 217 g of a composite having a SAN polymer matrix with dispersed silver was obtained. To determine the metal loading in the composite, the composite was burned at 600° C. to reduce the organic components to ash. The ash was then dissolved in dilute nitric acid and its silver content measured using the atomic absorption method. The silver content was determined to be 0.2% by weight.

### Example 5

152.7 g of styrene-acrylonitrile copolymer (LURAN® Q53) was dissolved in 551.4 g of MEK at room temperature, after which 7.5 g of the nano-silver powder dispersion in MEK prepared according to Example 3 was added. After 5 min. of stirring, the mixture was transferred to a flat baking mold and dried overnight at 100° C. After drying, 217 g of a composite having a SAN polymer matrix with dispersed silver was obtained. To determine the metal loading in the composite, the composite was burned at 600° C. to reduce the organic components to ash. The ash was then dissolved in dilute nitric acid and its silver content measured using the atomic absorption method. The silver content was determined to be 0.2% by weight.

### Example 6

A water-based dispersion (“DA-5”) of nano silver particles (“P202,” prepared as described in PCT WO 2004/000491, table 2, with Span 20 and hexadecanol, followed by washing to remove some of the Span 20 and hexadecanol) having the composition set forth in Table 2 was prepared as follows.

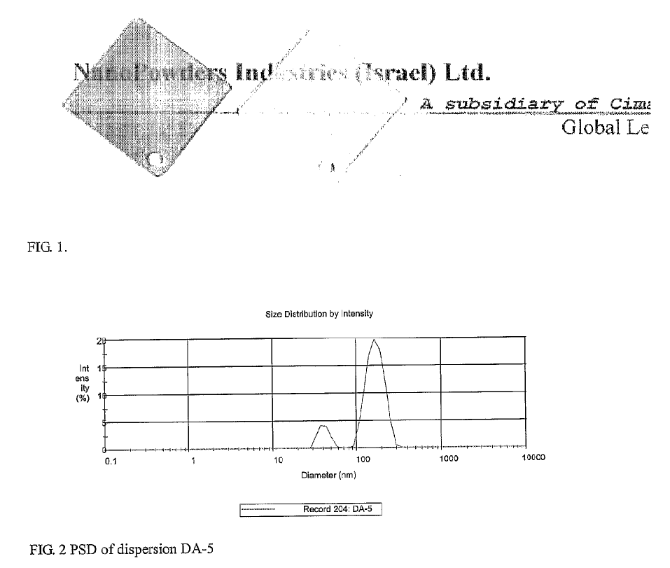

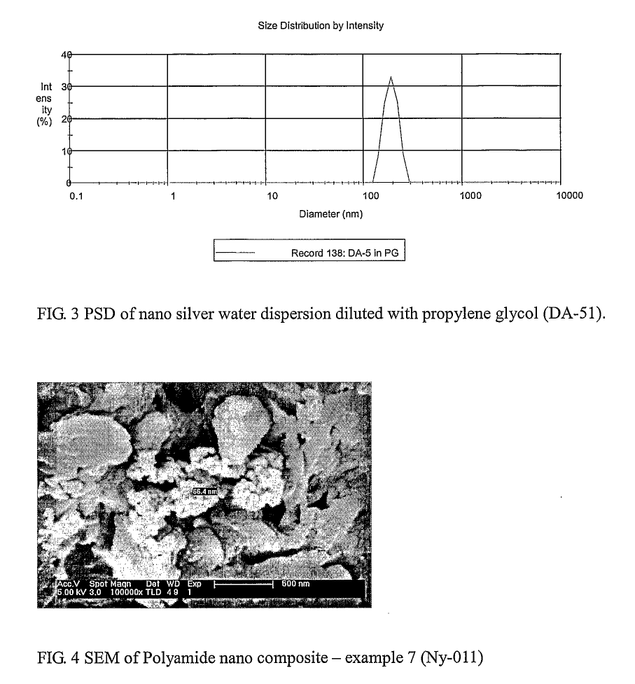

A 100 g mixture of the components described in Table 2 were ultrasonically treated according to the following profile (Bandelin nanopulse device with diamond coated probe 13 mm in diameter, total power 200 W): 2 min. at 50% power, 2 min. at 70% power, and 1 min. at 90% power. The particle size distribution (PSD) was measured using a Malvern Zetasizer Nano-S apparatus, and is presented in FIG. 2. The PSD shows 2 peaks: one at 171.4 nm and the other at 41 nm. The Zav was 124.5 nm. This dispersion was then diluted again by adding propylene glycol to a silver concentration of 10% by weight (6 times dilution). The composition of the resulting dispersion (“DA-51”) is shown in Table 3. The PSD of the resulting dispersion, measured as described above, is presented in FIG. 3. It shows a single peak at 192.9 n. The Zav was 169.7 nm.

TABLE 2
Composition of the dispersion DA-5

| Component | Name | % |
|---|---|---|
| Metal | P202 | 60 |
| Solvent | Water | 29.23 |
| Co-Solvents | NMP | 7.343 |
| | AMP | 0.147 |
| Additives | BYK-348 | 0.08 |
| | Disperbyk 190 | 3.0 |
| | PVP k15 | 0.2 |
| Total | | 100 |

TABLE 3
Composition of the dispersion DA-51

| Component | Name | % |
|---|---|---|
| Dispersion | DA-5 | 16.7 |
| Solvent | Propylene glycol | 83.3 |
| Total | | 100 |

### Example 7

A composite was prepared by adding the silver nano-particle dispersion (DA-51) described in Example 6 to a dissolved polyamide polymer and precipitating the nano composite according to the following procedure.

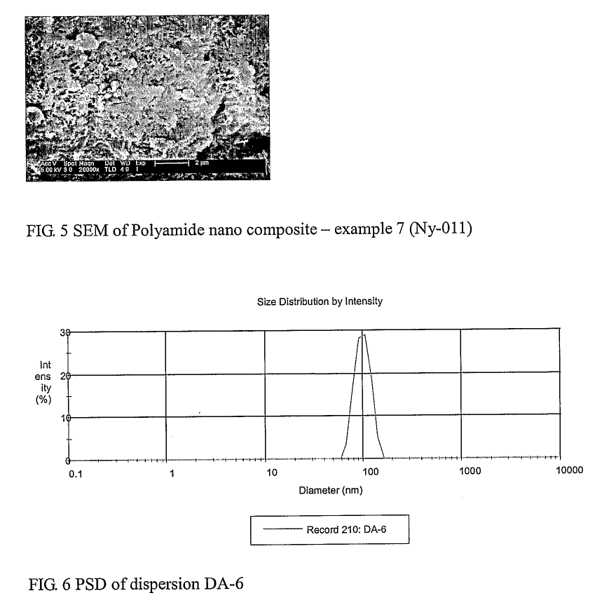

201.3 g of Nylon-6 was dissolved in 807.2 g of boiling propylene glycol containing 0.41 g (0.2% by weight based on polymer) Irganox-1098 (available from Ciba) as a stabilizer. After complete dissolution of the Nylon-6, 10 g of a 10% by weight silver nano-particle dispersion (DA-51) was added to the mixture and the mixture stirred for 5 min. more. Next, the hot mixture was poured into 5 liters of cold deionized water with stirring to precipitate the polymer. The precipitated polymer was rinsed with 2 liters of deionized water and then with 700 g of ethanol. The washed polymer was then dried overnight at 100° C. in a convection oven. After drying, 209 g of Nylon-6 containing 0.5% by weight of silver nano-particles was obtained and designated “NY-011.” SEM pictures of 2 different samples from this master-batch were taken and are included in FIGS. 4 and 5. The pictures show the presence of silver agglomerates measuring 1-2 μm in a Nylon-6 matrix.

### Example 8

The water-based, silver nano-particle dispersion described in Example 6 (DA-5) was diluted with a 75% by weight caprolactam water solution to 10% by weight of silver, and then with propylene glycol to a 5% by weight silver concentration. The dispersion was designated “DA-6.” PSD measurements of the dispersion were performed and are shown in FIG. 6. This dispersion shows enhanced stability relative to the dispersion in the absence of caprolactam.

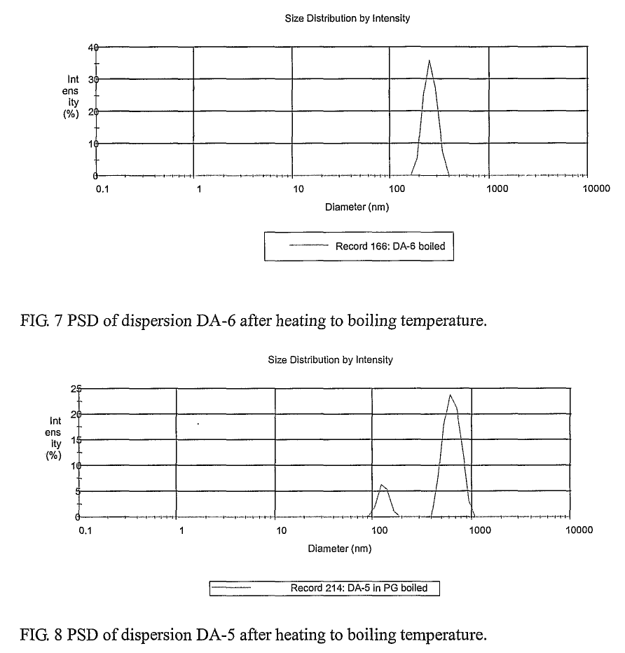

The dispersion was diluted with propylene glycol to a 0.2% by weight silver concentration, heated to the boiling temperature of the liquid carrier, and then maintained at these extreme conditions for 10 min. After cooling, the PSD of the dispersion was measured. The results are shown in FIG. 7. They show a single peak at 259.6 nm. The Zav value was 304.6 nm, with a maximum particle size of about 400 nm. Under the same conditions, dispersion DA-5, lacking caprolactam showed a greater particle size (a peak at 649.4 nm; Zav=429.3 nm, maximum particle size above 1 μm), as illustrated in FIG. 8.

The final composition of the DA-6 dispersion is presented in Table 4.

TABLE 4

| | Name | % |
|---|---|---|
| Metal | P202 | 5 |
| Solvents | Water | 12.853 |
| | NMP | 0.612 |
| | AMP | 0.012 |
| | Propylene Glycol | 50 |
| Additives | Caprolactam | 31.25 |
| | BYK-348 | 0.006 |
| | Disperbyk 190 | 0.25 |
| | PVP k15 | 0.017 |
| Total | | 100 |

### Example 9

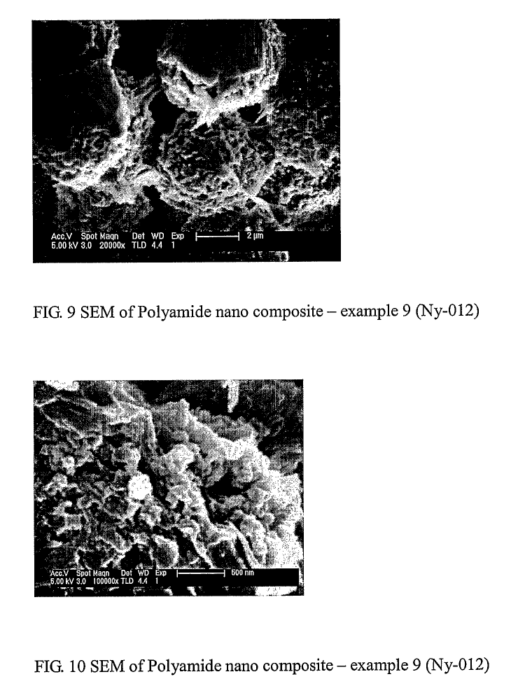

A masterbatch was made according to the following procedure. 200.3 g of Nylon-6 were dissolved in 801 g of boiling propylene glycol containing 0.41 g (0.2% by weight based on polymer) Irganox-1098 (available from Ciba) as a stabilizer. After complete dissolution of the Nylon-6, 40 g of a 5% by weight silver dispersion (DA-6, prepared as described in Example 8) was added to the mixture and the mixture stirred for 5 min. more. Next, the hot mixture was poured into about 10 liters of cold deionized water with stirring to precipitate the polymer. The precipitated polymer was rinsed with 1.5 liters of deionized water and then with 1 liter of ethanol. The washed polymer was then dried overnight at 100° C. in a convection oven. After drying, 205.4 g of Nylon-6 containing 1% by weight of silver nano-particles was obtained and designated “NY-012.” SEM pictures of 2 different samples from this masterbatch were taken and are included as FIGS. 9 and 10. No silver agglomerates are shown in the SEM pictures. It is possible to see only the polymeric matrix in the pictures. Bigger batches (three times larger) have been made with the same results.

### Example 10

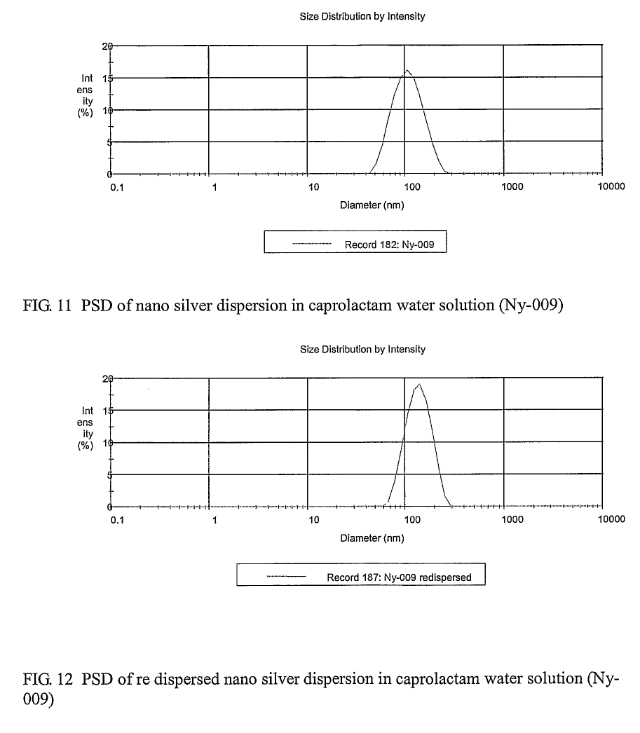

To 16 g of a 75% by weight caprolactam water solution, 0.197 g of a silver nano-particle dispersion (DA-5, prepared according to Example 6) was added and mixed using a magnetic stirrer. The PSD of the resulting dispersion was measured. The results are shown in FIG. 11. The dispersion was then dried at 100° C. for 75 min. and cooled to yield 11.35 g of a gray crystalline substance, designated “NY-009.” A portion of the sample was then re-dispersed in the caprolactam solution, and the PSD of the resulting dispersion. The results are shown in FIG. 12. The measurements demonstrate that the PSD of the re-dispersed silver is almost the same as in the dispersion before drying (PSD: Peak 112.6 nm, Zav=102.8 nm and for the re-dispersed sample Peak 141 nm, Zav=92.87 nm).

### Example 11

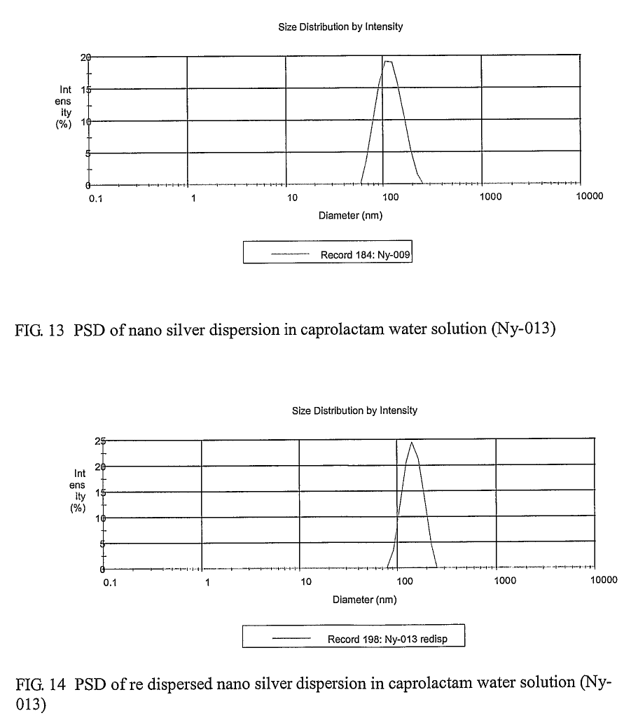

To 12 g of a 75% by weight caprolactam water solution, 1.68 g of a silver nano-particle dispersion (DA-5, prepared according to Example 6) was added and mixed using a magnetic stirrer. The PSD of the resulting dispersion was measured. The results are shown in FIG. 13. The dispersion was then dried at 100° C. for 2 hours and cooled to yield 10.7 g of a gray crystalline substance, designated “NY-013.” A portion of the sample was then re-dispersed in the caprolactam solution, and the PSD of the resulting dispersion. The results are shown in FIG. 14. The measurements demonstrate that the PSD of the re-dispersed silver is almost the same as in the dispersion before drying (PSD: Peak 120.9 nm, Zav=101.1 nm and for the re-dispersed sample Peak 146.5 nm, Zav=125.4 nm).

The nano-particle dispersions prepared in Examples 10 and 11 can be incorporated in a polymer (e.g., a polyamide polymer) to prepare a composite.

### Example 12

The anti-microbial properties of two representative composites, prepared as described below, were measured according to the “Efficacy Test Method for Anti-microbial Textile Products JISL 1902.” The test organism was Staphylococcus aureus (ATCC 6538). The duration of exposure was 24 hours at 37° C. The bacterial cell suspension for exposure was 1.6×105 CFL/ml. The blank used for comparative purposes was a sample of the polymer composite with no silver nano-particles. The results are shown in Table 5.

TABLE 5

| | Regenerated CFU/ml | |
|---|---|---|
| Tested Article | Trial 1 | Trial 2 |
| 102 | 287 | 38 |
| 103 | 387 | 13 |
| Blank | 1438 | 175 |

A dispersion of nano-silver particles (“P202,” prepared as described in PCT WO 2004/000491, Table 2, with Span 20 and hexadecanol, followed by washing to remove some of the Span 20 and hexadecanol) was prepared by mixing 75 g nano-silver powder and 50 g vehicle (7.5% Disperbyk 163, 0.1% Byk 333, and 99.4% ethylene glycol butyl ether acetate) and dispersed by means of an ultrasonic probe.

A first sample was prepared by adding the above dispersion (3.852 g) to a hot solution of polyamide 6 polymer (19.068 g), propylene glycol (77.042 g), and Irganox 1098 (Ciba-Geigy, 0.038 g) while mixing. The hot solution with the added dispersion was poured into 30 liters of cold water. The precipitate was filtered, washed with water (10 liters) followed by ethanol (4 liters), and dried in an oven at 100° C. until dry.

A second sample was prepared in the same manner with the dispersion (1.962 g) added to a hot solution of polyamide 6 polymer (19.522 g), propylene glycol (78.477), and Iranox 1098 (Ciba-Geigy, 0.039 g).

A number of embodiments of the invention have been described. Nevertheless, it will be understood that various modifications may be made without departing from the spirit and scope of the invention. Accordingly, other embodiments are within the scope of the following claims.

1. A composition comprising nano-metal particles dispersed in a liquid carrier that includes caprolactam.

2. A composition according to claim 1 wherein the nano-metal particles include a metal element selected from the group consisting of silver, gold, platinum, palladium, nickel, cobalt, copper, and combinations thereof.

3. A composition according to claim 1 wherein the nano-metal particles are prepared according to a process comprising: (a) forming an alloy comprising an auxiliary metal and a metal; and (b) treating the alloy with a leaching agent to remove the auxiliary metal.

4. A composition according to claim 3 wherein the auxiliary metal comprises aluminum.

5. A composition according to claim 1 wherein the nano-metal particles have a D₉₀ value of less than 0.1 μm.

6. A composition according to claim 1 wherein the composition is in the form of an emulsion.

7. A composition according to claim 1 wherein the composition comprises water, a water-miscible solvent, or a combination thereof.

8. A composition according to claim 1 wherein the composition comprises an organic solvent.

9. A composition according to claim 1 wherein the composition further comprises an agent selected from the group consisting of polymers, binders, surfactants, dispersants, coupling agents, and combinations thereof.

10. A composition according to claim 1 wherein the composition includes up to about 40% by weight caprolactam, based upon the total weight of the composition.

11. A composition according to claim 1 wherein the composition includes up to about 35% by weight caprolactam, based upon the total weight of the composition.

12. A composite comprising nano-metal particles in a solid polymer matrix wherein the nano-metal particles are prepared according to a process comprising: (a) forming an alloy comprising an auxiliary metal and a metal; and (b) treating the alloy with a leaching agent to remove the auxiliary metal.

13. A composite according to claim 12 wherein the auxiliary metal comprises aluminum.

14. A composite according to claim 12 wherein the nano-metal particles have a D₉₀ value of less than 0.1 μm.

15. A composite according to claim 12 wherein the polymer matrix comprises a thermoplastic polymer.

16. A composite according to claim 12 wherein the polymer matrix comprises a polyolefin.

17. A composite according to claim 12 wherein the polymer matrix comprises polyethylene.

18. A composite according to claim 12 wherein the polymer matrix comprises styrene-acrylonitrile (SAN) copolymer.

19. A composite according to claim 12 wherein the polymer matrix comprises acrylonitrile-butadiene-styrene (ABS) terpolymer.

20. A method of making a composite comprising:
(a) providing a masterbatch comprising nano-metal particles in a first polymer matrix; and
(b) combining the masterbatch with a second polymer that is the same as, or compatible with, the first polymer matrix, to form a composite comprising nano-metal particles in a matrix comprising the first and second polymers.

21. A method according to claim 20 wherein the second polymer is in the form of a polymer melt.

22. A method according to claim 20 wherein the second polymer is in the form of a polymer solution.

23. A method according to claim 20 wherein the first polymer comprises styrene-acrylonitrile (SAN) copolymer and the second polymer comprises acrylonitrile-butadiene-styrene (ABS) terpolymer.

24. A method according to claim 20 wherein the nano-metal particles include a metal element selected from the group consisting of silver, gold, platinum, palladium, nickel, cobalt, copper, and combinations thereof.

25. A method according to claim 20 wherein the nano-metal particles are prepared according to a process comprising: (a) forming an alloy comprising an auxiliary metal and a metal; and (b) treating the alloy with a leaching agent to remove the auxiliary metal.

26. A method according to claim 25 wherein the auxiliary metal comprises aluminum.

27. A method to claim 20 wherein the nano-metal particles have a D₉₀ value of less than 0.1 μm.

28. A method of making a composite comprising:
(a) providing a first composition comprising nano-metal particles dispersed in a liquid carrier;
(b) combining the composition with a solution comprising a first polymer dissolved in a solvent to form a second composition; and
(c) precipitating a composite comprising nano-metal particles and the first polymer from the second composition.

29. A method according to claim 28 further comprising drying the precipitate composite to remove any residual solvent.

30. A method according to claim 28 further comprising combining the composite with a second polymer that is the same as, or compatible with, the first polymer to form a second composite comprising nano-metal particles in a matrix comprising the first and second polymers.

31. A method according to claim 28 wherein the liquid carrier includes caprolactam.

32. A method according to claim 28 wherein the first composition is in the form of an emulsion.

33. A method according to claim 28 wherein the first composition comprises water, a water-miscible solvent, or a combination thereof.

34. A method according to claim 28 wherein the first composition comprises an organic solvent.

35. A method according to claim 28 wherein the first composition further comprises an agent selected from the group consisting of polymers, binders, surfactants, dispersants, coupling agents, and combinations thereof.

36. A method according to claim 28 wherein the first composition includes up to about 40% by weight caprolactam, based upon the total weight of the first composition.

37. A method according to claim 28 wherein the first composition includes up to about 35% by weight caprolactam, based upon the total weight of the first composition.

38. A method according to claim 28 wherein the nano-metal particles include a metal element selected from the group consisting of silver, gold, platinum, palladium, nickel, cobalt, copper, and combinations thereof.

39. A method according to claim 28 wherein the nano-metal particles are prepared according to a process comprising: (a) forming an alloy comprising an auxiliary metal and a metal; and (b) treating the alloy with a leaching agent to remove the auxiliary metal.

40. A method according to claim 39 wherein the auxiliary metal comprises aluminum.

41. A method to claim 28 wherein the nano-metal particles have a D₉₀ value of less than 0.1 μm.
